(19) United States
(12) Patent Application Publication
(10) Pub. No.: US 2026/0064977 A1
(43) Pub. Date: Mar. 5, 2026

(54) CAPTION GENERATION FOR DIGITAL CONTENT

(71) Applicant: Adobe Inc., San Jose, CA (US)

(72) Inventors: Yaman Kumar, New Delhi (IN); Somesh Singh, Lucknow (IN); Pamela Zoni, London (GB); Lawrence Smith, Buckinghamshire (GB); Deepak Shukla, Bangalore (IN); Avadhesh Kumar Sharma, Jhunjhunu (IN); Julian Hamm, Watford (GB)

(73) Assignee: Adobe Inc., San Jose, CA (US)

(21) Appl. No.: 18/819,418

(22) Filed: Aug. 29, 2024

(51) Int. Cl. G06F 40/40; G06F 40/103; G06F 40/166; G06F 40/289; G06N 20/00

(52) U.S. Cl. CPC G06F 40/40; G06F 40/103; G06F 40/166; G06F 40/289; G06N 20/00

(57) ABSTRACT

In implementations of systems for generating captions, a processing device implements a caption generation service to receive an input for caption generation that includes a text input indicating example language or content for the caption and an action input indicating a desired action. The processing device receives the text input via a user interface. The caption generation service generates a textual prompt for a machine-learning model based on the action input and text input. The machine-learning model uses the textual prompt to generate the caption in a specified structural format. The processing device then causes the generated caption to be presented to a user via the user interface.

### BACKGROUND

Digital content creators employ various techniques to prepare digital images, videos, or audio for optimal distribution. Captions are essential to enhance the impact and reach of digital content, especially on social media and other online distribution channels. Nevertheless, compelling captions can be daunting and time-consuming, even for experienced creators.

Although some conventional content creation services offer tools for creating captions, the conventional content creation services often fail to provide a desired voice and format. This failure leads to an unproductive and imprecise “best guess” approach, which falls short of the desires of many content creators, inaccuracies, and inefficient use of computational resources.

### SUMMARY

Techniques and systems for generating captions for digital content are described. In one example, a processing device receives via a user interface a request for caption generation that includes textual details for the caption and an action request. The text details are provided as words input by the user or extracted from digital media uploaded by the user. The processing device then generates a textual prompt based on the textual details and the action request for a machine-learning model, which generates a caption in a specified structural format. The processing device outputs the generated caption via the user interface.

This Summary introduces a simplified selection of concepts that are further described below in the Detailed Description. As such, this Summary is not intended to identify essential features of the claimed subject matter or to aid in determining its scope.

### BRIEF DESCRIPTION OF THE DRAWINGS

The detailed description is described with reference to the accompanying figures. Entities represented in the figures are indicative of one or more entities, and thus, reference is made interchangeably to single or plural forms of the entities in the discussion.

FIG. 1 illustrates a digital medium environment in an example implementation that is operable to employ caption generation for digital content as described herein.

FIG. 2 depicts a system in an example implementation showing operation of a caption generation service of FIG. 1 in greater detail as employing the techniques described herein.

FIG. 3 depicts a procedure in an example implementation showing the operation of a prompt generation module to employ the techniques described herein to generate a textual prompt for a machine-learning system.

FIG. 4 illustrates an example image included as digital media in the input.

FIG. 5 illustrates an example user interface for a user to provide input data.

FIG. 6 depicts a system and procedure in an example implementation for training a machine-learning model.

FIG. 7 illustrates an example of a generated caption from a user's input.

FIG. 8 illustrates an example block diagram of components utilized to generate captions.

FIG. 9 is a flow diagram depicting a procedure in an example implementation in which a machine-learning model generates a caption from digital content.

FIG. 10 illustrates an example system with an example computing device representative of one or more computing systems and/or devices usable to implement the techniques described herein.

### DETAILED DESCRIPTION

### Overview

Creating compelling captions to accompany digital media or announce an upcoming event is often daunting and time-consuming. Some conventional content creation services offer artificial intelligence tools to generate captions. These tools, however, generate captions in conversation-like language with details that are often made up or hallucinated. In addition, such tools often struggle to properly process uploaded digital media to supplement or replace text input by the user. To overcome these and other limitations of conventional approaches, techniques and systems are described herein to generate captions for digital content.

For example, a service provider system implements a caption generation service to receive an input that includes a text input with example language or content for the caption and an action input indicating a desired action. Examples of action input include shortening, lengthening, rewriting, or improving the persuasiveness of the text input. The text input includes words provided by a user or text extracted from or describing digital media uploaded by the user. The input optionally also includes distribution channels for the caption.

The caption generation service generates a textual prompt for a machine-learning model based on the received input. An example of the machine-learning model includes a large language model (LLM) that uses the textual prompt to generate the caption in a specified structural format. In some implementations, the specified structural format includes a header section, a body section with one or more paragraphs, and a conclusion. For some distribution channels, the conclusion includes one or more hashtags. The caption is then presented to the user via the user interface.

Consider that an entrepreneur has started a modern coffee shop called “Charm Coffee,” but the entrepreneur does not have sufficient funds for a marketing budget. Therefore, the entrepreneur manually creates the promotional posts. Next week, the entrepreneur may then wish to run a promotion to attract new customers: “20% off all day on August 3.” The entrepreneur has taken a welcoming photo of the interior of Charm Coffee but struggles to come up with a captivating caption to generate excitement for the upcoming promotion.

The entrepreneur provides the photo and the promotion text (e.g., “Charm Coffee is offering 20% off all day on August 3”) as inputs to a caption generation service. Via a user interface, the entrepreneur also indicates that they want a persuasive caption generated for distribution on a particular social media platform. In other examples, the entrepreneur adds instructions for the captions, like “make it light-hearted.”

The caption generation service uses a prompt generation module to construct a textual prompt for a machine-learning model based on the requested action and the other inputs. The photo is processed to extract any included text and generate content tags describing the content and intention of the photo, e.g., a comfortable lounging area with modern and aesthetically pleasing furniture. In this way, the photo or other uploaded digital content is textualized into a story format to bypass the limitations of many machine-learning models, e.g., being unable to process videos. In addition, by providing the extracted text and content tags to the machine-learning model solely, the caption generation service focuses the machine-learning model on relevant details provided by the entrepreneur while ignoring irrelevant details included in the photo.

In some implementations, the textual prompt also includes instructions for a particular persuasion strategy, which the entrepreneur may be able to select from a list. The persuasion strategy allows the described caption generation service to provide more relevant captions than those generated using conventional tools. If the entrepreneur indicates a distribution channel, the textual prompt also includes channel-specific instructions to optimize the generated caption for that channel.

The machine-learning model generates a caption based on the textual prompt in a specified structural format. In some examples, the specified structural format is a JavaScript Object Notation (JSON) data format with a header, one or more body paragraphs, and a conclusion (e.g., multiple hashtags). By specifying the structural format, the machine-learning model professionally generates captions and avoids the conversational responses of conventional content creation tools. In addition, the described caption generation service instructs the machine-learning model to add placeholders for any missing details rather than fabricating them.

The generated caption is then presented to the entrepreneur via the user interface. Before presentation, the caption may be analyzed to ensure compliance with the specified structural format, consistent brand tone with previously accepted captions, and other instructions in the textual prompt.

The described caption generation techniques result in effective captions in a desired format without devolving into a free-form conversational style, saving users time. In addition, the generated captions are more relevant to the user's input by textualizing photos and other digital content into a story format to focus the machine-learning model on essential details. The textualization of digital content also saves processing resources for the machine-learning model and avoids the technical inabilities, e.g., being unable to process videos, of some machine-learning models. Lastly, users can generate effective captions for one or several distribution channels without knowing or recalling the suggested or required language, tone, or length for each channel.

In the following discussion, an example environment is first described that employs examples of techniques described herein. Example procedures are also described which are performable in the example environment and other environments. Consequently, performance of the example procedures is not limited to the example environment and the example environment is not limited to performance of the example procedures.

### Example Caption Generation Environment

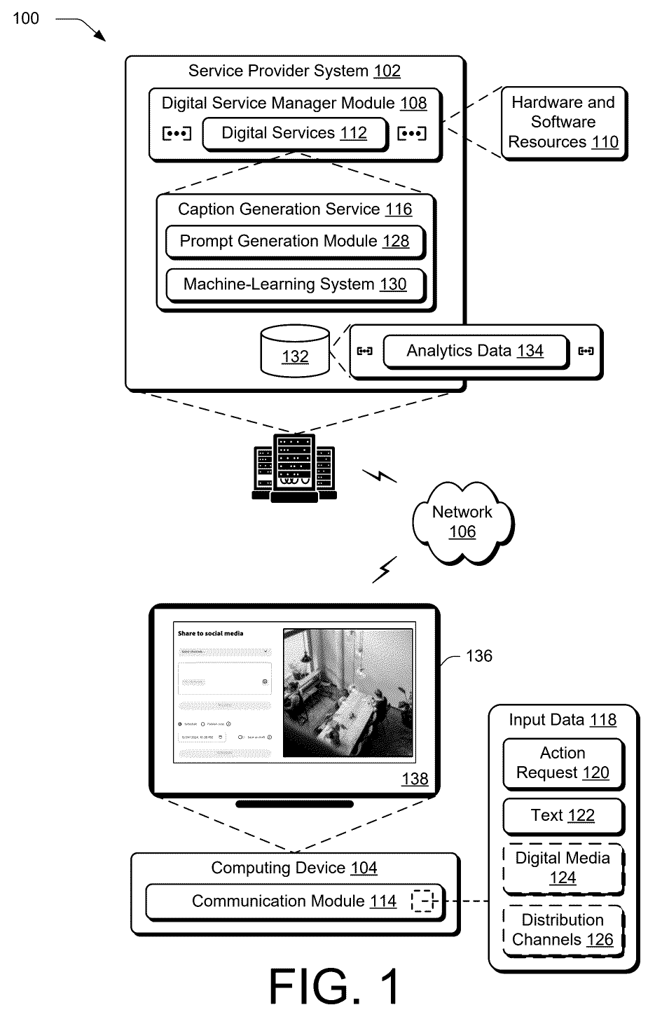

FIG. 1 is an illustration of a digital medium environment 100 in an example implementation that is operable to employ caption generation for digital content as described herein. The illustrated environment 100 includes a service provider system 102 and a computing device 104 that are communicatively coupled, one to another, via a network 106. Computing systems for the service provider system 102 and the computing device 104 are configurable in a variety of ways. For instance, computing device 104 is associated with a user, and service provider system 102 is a remote computing system (e.g., one or more servers) configured to employ the described techniques and systems for caption generation.

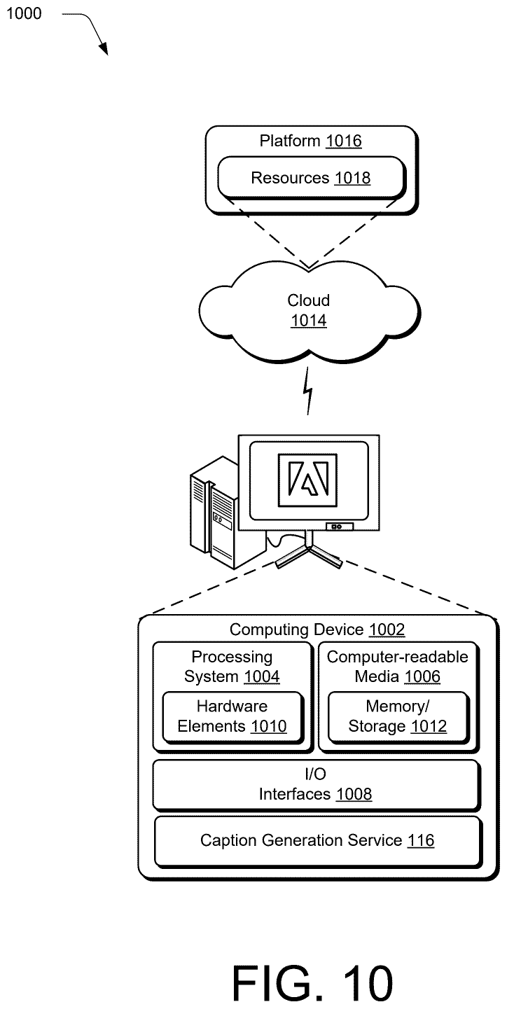

A computing system, for instance, is configurable as a desktop computer, laptop computer, mobile device (e.g., assuming a handheld configuration such as a tablet or mobile phone), server, and so forth. Thus, the service provider system 102 or the computing device 104 is capable of ranging from a full-resource device with substantial memory and processor resources (e.g., servers and personal computers) to a low-resource device with limited memory and/or processing resources (e.g., some mobile devices). Additionally, although a single computing device is shown for the computing device 104 and described in instances in the following discussion, a computing system is also representative of a plurality of different devices, such as multiple servers utilized by a business to perform operations “over the cloud” for the service provider system 102 and as further described in relation to FIG. 10.

The service provider system 102 includes a digital service manager module 108 implemented using hardware and software resources 110 (e.g., a processing device and computer-readable storage medium) to support one or more digital services 112. Digital services 112 are made available remotely via the network 106 to computing devices (e.g., computing device 104).

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on. Accordingly, in the illustrated example, a communication module 114 (e.g., browser, network-enabled application, and so on) is utilized by the computing device 104 to access the digital services 112 via the network 106. A result of processing using the digital services 112 is then returned to the computing device 104 via the network 106.

In the illustrated digital medium environment 100, the digital services 112 include a caption generation service 116 for writing, shortening, lengthening, or rewriting input data 118 to provide captions. For example, the caption generation service 116 is a feature of another digital service 112 (e.g., a digital content scheduler). A user of the computing device 104 accesses the caption generation service 116 utilizing the communication module 114. In response to a prompt or as part of a user interface, the user provides input data 118 to the caption generation service 116 via the computing device 104.

The input data 118 includes an action request 120 and text 122 to be processed for caption generation. The action request 120 indicates a requested action to be performed by the caption generation service 116. Potential action requests include generating a new caption from the text 122, shortening the text 122, lengthening the text 122, making the first line a “hook,” rewriting the text 122, summarizing the text 122, adding a call to action, rewriting the text 122 as a bullet list or influencer post, and otherwise editing the text 122. The text 122 includes an initial draft of a caption provided by the user, details (e.g., time, date, location, venue, names, links) for the caption, or instructions for the caption generation service 116 (e.g., add humor, adhere to a word limit, etc.).

The input data 118 optionally includes digital media 124 and distribution channels 126. The digital media 124 may be an image, video, graphic, sequence of images, pamphlet, audio message, or other multimedia content. In the example described above, the digital media 124 is a photograph of an interior seating area of a coffee shop. In some instances, the digital media 124 substitutes for or supplements the text 122 as described in greater detail below. The distribution channels 126 indicate the user's selection of one or more distribution channels (e.g., social media platforms) to which the generated caption and (optional) associated digital media 124 are to be uploaded. For example, the distribution channels 126 may include one or more of Instagram®, X® (formerly Twitter®), Facebook®, Pinterest®, LinkedIn®, or another social media platform.

The caption generation service 116 utilizes a prompt generation module 128 and a machine-learning system 130 to provide the services and techniques described herein. In particular, the caption generation service 116 receives the input data 118 and provides or forwards it to the prompt generation module 128. The prompt generation module 128 processes the input data 118 to construct a textual prompt for the machine-learning system 130.

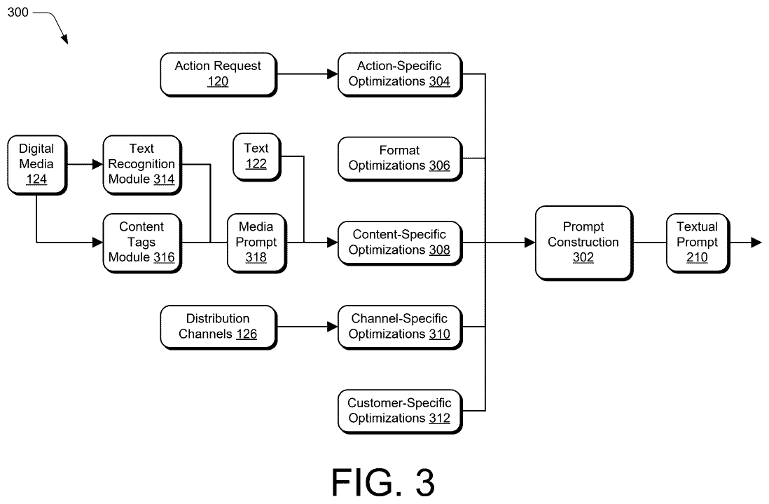

The textual prompt includes the action request 120 and text 122. If provided, the prompt generation module 128 uses text recognition models to extract text from the digital media 124. Image tagging models are also used to generate a textual description of the digital media 124. In some scenarios, the textual prompt for the machine-learning system 130 only includes the action request 120 and extracted text and textual description from the digital media 124. The generated prompt also includes channel-specific considerations (if the distribution channels 126 are provided) as textual instructions or parameters for the machine-learning system 130. The prompt generation module 128 sets a specified structural format for the generated caption, such as an input-output structure as opposed to a free-form response. In this way, the caption generation service 116 imposes a specified response structure and avoids conversation-like responses that are common for many machine learning and artificial intelligence systems. Additionally, techniques of the prompt generation module 128 are described in greater detail with respect to FIG. 3.

The machine-learning system 130 uses a machine-learning model to process the textual prompt with input values and parameters and generate a caption. The machine-learning model is a computer representation that can be tuned (e.g., trained and retrained) based on inputs to approximate unknown functions. In particular, a machine-learning model utilizes algorithms to learn from and make predictions on known data by analyzing training data to learn and relearn to generate outputs that reflect patterns and attributes of the training data. According to various implementations, the machine-learning model uses supervised, semi-supervised, unsupervised, reinforcement, and/or transfer learning. For example, the machine learning model is capable of including but is not limited to clustering, decision trees, support vector machines, linear regression, logistic regression, Bayesian networks, random forest learning, dimensionality reduction algorithms, boosting algorithms, artificial neural networks (e.g., fully-connected neural networks, deep convolutional neural networks, or recurrent neural networks), deep learning, etc. Examples of machine-learning models include neural networks, convolutional neural networks (CNNs), long short-term memory (LSTM) neural networks, decision trees, and so forth.

In one implementation, the machine-learning system 130 uses a large language model (LLM) to generate captions. LLMs are machine-learning models designed to understand, generate, and interact with human language inputs at a large scale. These models are trained on vast amounts of text data using deep learning techniques (e.g., neural networks) to learn patterns, nuances, and the structure of language. The use of the term “large” refers to both the size of the training data and also to the complexity and scale of the neural networks, which may include billions or even trillions of parameters.

LLMs are configurable to perform a wide range of language-related tasks without being explicitly programmed for each one. These tasks include text generation, translation, summarization, question answering, sentiment analysis, and natural language processing. To train an LLM, the underlying machine-learning model is provided with training data that includes examples of text to train and retrain the model to predict the next word in a sequence. Over time, the model, once trained, is configured to generate text that is coherent and contextually relevant, configurable to mimic the style and content of the training data, and so forth. In this way, LLMs provide a foundational tool in artificial intelligence for understanding and generating human language, powering a wide range of applications from conversational agents to content creation tools, including caption writing.

The service provider system 102 also includes a storage device 132, illustrated to include analytics data 134, which describes historical information about digital content (e.g., digital media and/or associated captions) and interactions with the digital content. For example, the analytics data 134 describes digital content distributed and monitored via a content distribution channel or multiple content distribution channels as well as a composition or substance of the digital content (e.g., text, images, colors, intents, etc.), layouts of emojis and hashtags included in the digital content, timestamps associated with distributing the digital content via the content distribution channels, and so forth. The analytics data 134 also describes how the digital content was received via the content distribution channels. Examples of which include the number of times the digital content was viewed, the number of comments received relative to the digital content, the sentiment/context of these comments, whether the digital content was shared or liked and how many times, whether the digital content was rated positively or negatively and how many times, etc.

In an example, the analytics data 134 describes how interactions with the digital content are performed such as tactilely via touch (e.g., using a touchscreen input device), scrolling (e.g., using a mouse input device), keystrokes (e.g., using a keyboard input device), voice commands (e.g., using a microphone input device), and so forth. In this example, the analytics data 134 is capable of describing human-based information about interactions with the digital content, such as eye movements of users (e.g., using gaze tracking), whether the digital content is consumed by a single user or simultaneously by multiple users, etc.

The analytics data 134, for instance, describes information specific to particular distribution channels. For example, this distribution-channel-specific information generalizes observations from particular distribution channels, such as digital content with digital images or a light-hearted or humorous caption generally outperforms digital content with relatively long text sequences in particular distribution channels. In another example, the distribution-channel-specific information clarifies differences between observations from particular distribution channels and observations from across many distribution channels based on content length, hashtags, emojis, tonality, and other characteristics. For instance, across many distribution channels, digital content with a positive sentiment generally outperforms digital content with a negative sentiment; however, in a particular distribution channel, digital content with a negative sentiment generally outperforms digital content with a positive sentiment.

Once a caption is generated, the service provider system 102 communicates the caption to the computing device 104 via the communication module 114. The computing device 104 outputs the generated caption to the user via a display device 136 that is communicatively coupled to the computing device 104 via a wired or wireless connection. The service provider system 102 or the caption generation service 116 may also communicate a user interface 138 for presenting the generated caption and facilitating user feedback.

As illustrated in FIG. 1, the service provider system 102 uses inputs received via the user interface 138 of the computing device 104 to generate a textual prompt for a machine-learning system 130. The machine-learning system 130 uses the textual prompt to generate a caption for the user. In the following discussion, an example system, e.g., the caption generation service 116, is first described, employing examples of techniques described herein. Example procedures are also described which are performable in the example system and other systems. Consequently, the performance of the example procedures is not limited to the example system, and the example system is not limited to the performance of the example procedures.

### Example Caption Generation System and Techniques

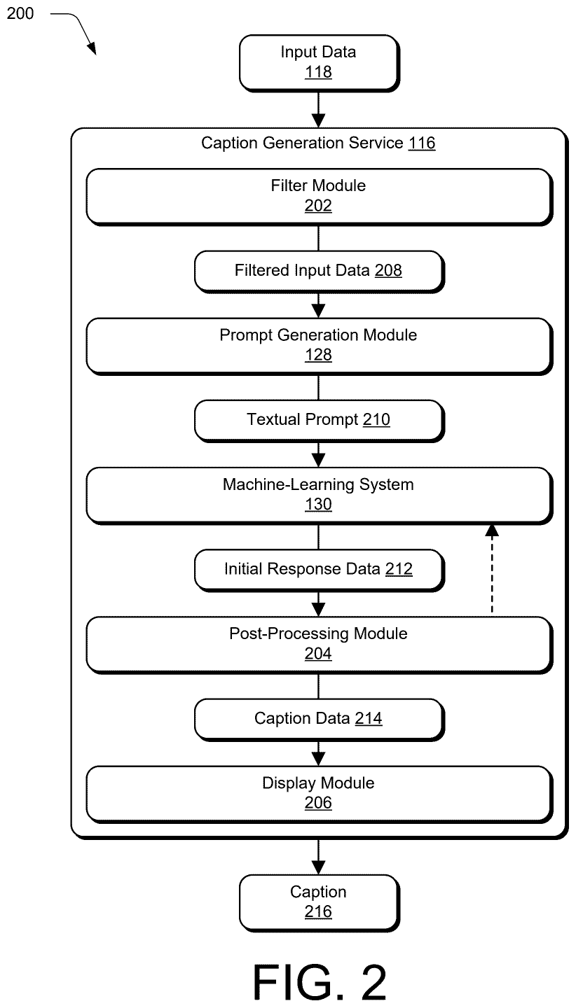

FIG. 2 depicts a system 200 in an example implementation showing the operation of a caption generation service 116 of FIG. 1 as employing the techniques described herein. The caption generation service 116 is illustrated to include a filter module 202, the prompt generation module 128, the machine-learning system 130, a post-processing module 204, and a display module 206.

In the example implementation, the filter module 202 receives and processes the input data 118 to generate filtered input data 208. For instance, the filter module 202 analyzes the input data 118 to minimize exposure to harmful and offensive content and ensure a diverse representation of people, cultures, and identities in the caption generation process. The filter module 202 also analyses the input data 118 to identify and mitigate unintended consequences. Examples of unintended consequences include unexpected results that could return a harmful result based on the language or image in a prompt. The filter module 202 prevents intentional system abuse by screening inputs designed to purposely cause the caption generation service 116 to generate negative or harmful captions.

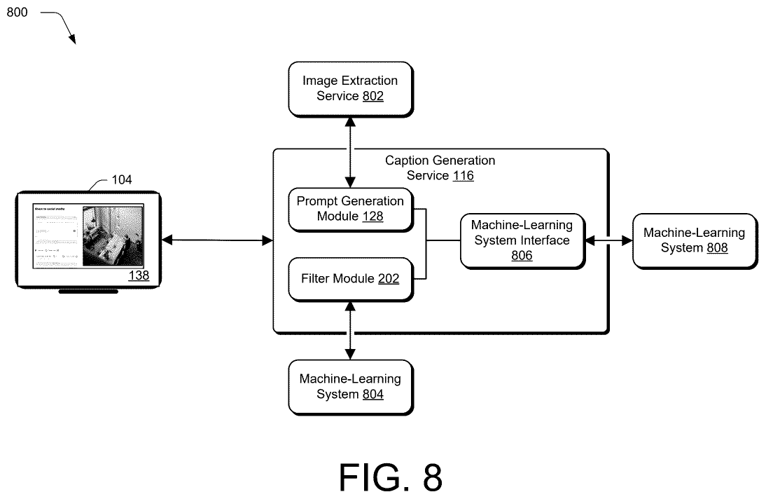

The filter module 202 uses block-and-deny lists to reduce the possibility of harmful content being generated by the caption generation service 116. Block-and-deny lists include a curated list of words for which a machine-learning model is expressly instructed to avoid generating outputs. In response to a blocked prompt, the filter module 202 generates an error message or alert instead of generating a caption. In another implementation, a denied prompt leads to caption generation with the suppressed word removed and a popup stating that the prompt does not meet caption generation criteria. If the input data 118 does not include blocked or denied content, the input data 118 is passed through as the filtered input data 208. The relationship between the filter module 202 and a machine-learning model used for filtering the input data 118 is described in greater detail with respect to FIG. 8.

As another example, the filter module 202 uses classifiers and filters to reduce instances of graphic or Not Safe for Work content. It evaluates whether those instances are blocked harmful terms that did not appear in block-and-deny lists. The filter module 202 also evaluates the input data 118 against a bypass list, which includes allowed words, terms, or phrases that the machine-learning model is not mature enough to understand. Before caption generation is complete, the filter module 202 or the post-processing module 204 considers whether the generated caption contains exploitative or hateful content. In other instances, the filter module 202 uses debiasing tools to intentionally reduce bias in captions generated by machine-learning models regarding how humans are represented and portrayed. By applying country or cultural specifics to prompts, stereotypes and misrepresentation are reduced.

The prompt generation module 128 receives and processes the filtered input data 208 to generate one or more textual prompts 210 for the machine-learning system 130. As described in detail with respect to FIG. 3, the prompt generation module 128 identifies a persuasion strategy (e.g., social identity, tone, readability, concreteness, emotion, anchoring, guarantees, etc.) and constructs the textual prompt 210 to reflect the chosen persuasion strategy.

The prompt generation module 128 also processes any digital media 124 in the input data 118 to textualize the passed media in a story or descriptive format, allowing the machine-learning system to include relevant details in the generation caption 216. In addition, the textual prompt 210 is constructed to require the output of the machine-learning system 130 to be in a specified structural format (e.g., JSON data structure). In this way, the caption generation service 116 avoids the generation caption 216 having a free-form, conversation-like format, which may be disfavored for marketing purposes.

FIG. 3 depicts a procedure 300 in an example implementation showing the operation of the prompt generation module 128 to employ the techniques described herein to generate a textual prompt 210 for the machine-learning system 130. The prompt generation module 128 is illustrated as performing action-specific optimizations 304, format optimizations 306, content-specific optimizations 308, channel-specific optimizations 310, and customer-specific optimizations 312 as part of prompt construction 302. In other implementations, the prompt generation module 128 performs fewer or additional optimizations.

In response to receiving the action request 120 as part of the input data 118, the prompt generation module 128 performs action-specific optimizations 304. For example, the prompt generation module 128 supports the following actions: rephrase, shorten, lengthen, grammar correction, and rewrite (e.g., as a bullet list, announcement, question, or influencer post). The action-specific optimization 304 includes composing a separate prompt for each supported or available action. In response to “shorten it,” the prompt generation module 128 adds an instruction to rewrite text 122 to reduce its length by a specified amount (e.g., twenty-five percent). Similarly, the textual prompt 210 includes instructions to rewrite text 122 to increase its length by a specified amount (e.g., forty percent) to “lengthen it.” The prompt generation module 128 composes similar instructions in the textual prompt 210 as part of the action-specific optimizations 304.

In some examples, the textual prompt 210 also instructs the machine-learning system 130 to select from a list of potential persuasion strategies for the caption. The persuasion strategies include social identification, social proof, concreteness, emotion, concreteness, anthropomorphism, guarantees, tone, readability, anchoring and comparison, foot in the door, and others. The machine-learning system 130 selects a persuasion strategy based on the input data 118 or prior accepted captions.

In other examples, the prompt generation module 128 prompts the machine-learning system 130 to infuse emotions in the caption, thus establishing stronger connections with the audience. In the coffee shop example above, the textual prompt 210 instructs the machine-learning system 130 to explore feelings, emotions, or relatable experiences that resonate with the input data 118. Likewise, the textual prompt 210 may direct the machine-learning system 130 to evoke curiosity, excitement, or empathy among caption readers.

Format optimizations 306 ensure that the generated captions are returned by the machine-learning system 130 in a specified structural format. Conventional machine-learning models generally return responses in a conversation-like style without a specific structure. In contrast, the prompt generation module 128 requests an input-output response from the machine-learning system 130. To achieve this, the format optimizations 306 impose a JSON structure or other specified structural format as part of the textual prompt 210 that generally includes a header, one or two body paragraphs, and a conclusion (e.g., hashtags, emojis, short sentences, or a combination thereof). The specified structural format maintains the input-output format and avoids devolving into a conversation-like structure. In one implementation, the header or body paragraphs include one or more non-text characters (e.g., emojis, emoticons, or hashtags) and the conclusion line includes one or more non-text contextual characters (e.g., hashtags, at signs, symbols, or emojis).

Similarly, format optimizations 306 ensures the generated caption does not include hallucinated or made-up details. The machine-learning system 130 adds supplementary information, behind-the-scenes content, or exclusive insights related to the input data 118 in the form of statistics, quotes, or intriguing facts to amplify the caption's value. Conventional machine-learning models often make up or insert details into generated responses to provide a complete response. To avoid this, the textual prompt 210 instructs the machine-learning system 130 to identify missing details (e.g., venue, date, names, links) and suggest placeholders. In this way, the prompt generation module 128 controls the level of factuality in the generated captions.

Content-specific optimizations 308 allow the content and intention of the digital media 124 to be included in the generated caption. As discussed above, digital media 124 includes videos, images, graphics, image sequences, and text. A text recognition module 314 uses optical character recognition or a similar technique to recognize and extract text (e.g., details included by a user in a previously-generated poster, invitation, or flyer) from the digital media 124. A content tags module 316 uses an image tagging model to understand and describe the digital media 124 with textual content tags. The extracted text and content tags combine to create a media prompt 318 in words to substitute for the digital media 124.

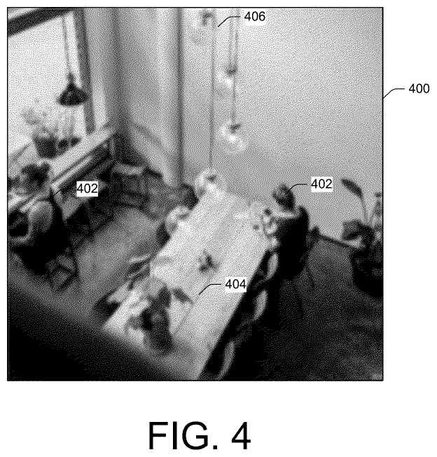

FIG. 4 illustrates an example image 400 included as the digital media 124 in the input data 118. Image 400 depicts the seating area of Charm Coffee from the earlier-mentioned scenario. The text recognition module 314 processes image 400, but does not identify any text to extract. The content tags module 316 identifies image tags 402, 404, and 406 from the photograph. Image tag 402 identifies people enjoying their drinks at the coffee shop. Image tag 404 describes the table and high bar as an interior accommodating many people to socialize and enjoy their drinks. Image tag 406 indicates the coffee shop includes modern lighting and aesthetics. These image tags are combined with the extracted text (e.g., none in image 400) to generate the media prompt 318.

The media prompt 318 is then combined with the text 122 to generate the user input portion of the textual prompt 210. In this way, a textual description of the digital media 124, as opposed to the digital media 124 itself, is used in the textual prompt 210. By avoiding a weakness of some machine-learning models to process certain media types (e.g., videos or audio messages), the prompt generation module 128 reduces the complexity and processing requirements (e.g., tens or hundreds of cogs) for the machine-learning system 130.

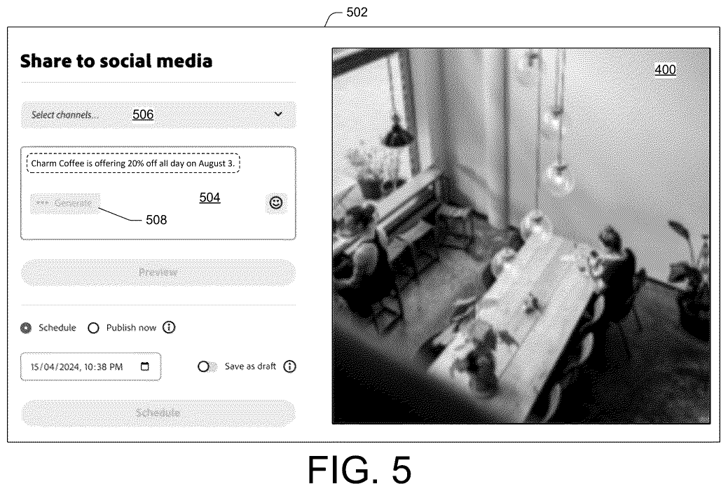

FIG. 5 illustrates an example user interface 502 for a user to provide the input data 118. The user interface 502 includes a text entry box 504, dialog box 506, and radio button 508 as interactive elements. Continuing the coffee shop example, the user types “Charm Coffee is offering 20% off all day on August 3” in the text entry box 504 to form the text 122. In this example, the user has not selected a distribution channel in the dialog box 506. The user also uploads image 400 as digital media 124. In other scenarios, the user provides text 122 or digital media 124 (especially if it contains textual details for the caption) instead of both. The user then selects the radio button 508 to select an action request 120.

Channel-specific optimizations 310 account for users releasing digital content on various distribution channels (e.g., social media platforms). Based on imposed technical limitations or the type of audience thereon, different distribution channels require different lengths, hashtags, emojis, or tones. The prompt generation module 128 accounts for these different channel requirements in generating the textual prompt 210. In this way, the user provides the same input data 118 to generate effective captions for one or several distribution channels without knowing or recalling language, tone, or length requirements for each channel. The prompt generation module 128 generates a single textual prompt 210 that harmonizes the requirements of each distribution channel 126 (e.g., maximum length). In another implementation, the prompt generation module 128 generates separate textual prompts 210 for each distribution channel 126. The specific optimizations 310 also ensure that the appropriate tone (e.g., avoid satire, derogatory comments, irony, or inappropriate content) is provided in the generated caption.

Customer-specific optimizations 312 allow the prompt generation module 128 to consider specific aspects of a user's profile (e.g., job title, job details, employer, age, associated business details) to include in the textual prompt 210. The passed user details allow machine-learning system 130 to personalize the generated captions without including them (e.g., any personal or sensitive information) in the generated captions. Such details are available and used only if approved or enabled by the user.

The prompt generation module 128 combines the output from optimizations 304-312 to perform prompt construction 302 and output the textual prompt 210. The machine-learning system 130 receives and processes the textual prompt 210 using a machine-learning model to generate initial response data 212. The initial response data 212 is an initial or draft caption generated by the machine-learning model in the specified structural format.

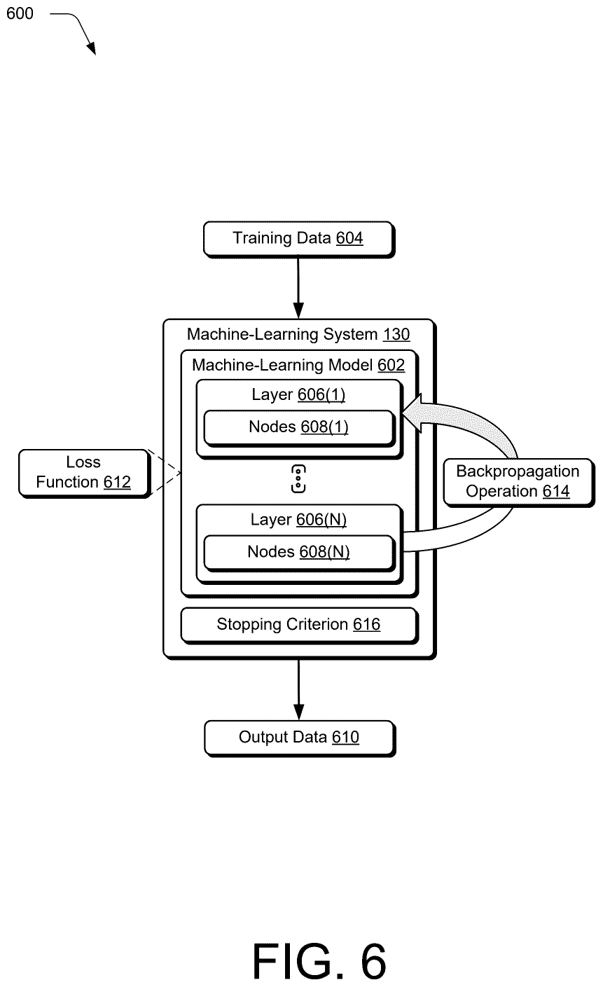

FIG. 6 depicts a system and procedure in an example implementation 600 for training a machine-learning model 602 as part of the machine-learning system 130 of FIG. 1. The machine-learning model 602 is illustrated as implemented as part of the machine-learning system 130. The machine-learning system 130 is representative of functionality to generate training data 604, use the generated training data 604 to train the machine-learning model 602, and/or use the trained machine-learning model 602 as implementing the functionality described herein.

A machine-learning model 602 refers to a tunable computer representation (e.g., through training and retraining) based on inputs without being actively programmed by a user to approximate unknown functions, automatically and without user intervention. In particular, the term machine-learning model includes a model that utilizes algorithms to learn from and make predictions on known data by analyzing training data to learn and relearn to generate outputs (e.g., captions 216) that reflect patterns and attributes of the training data. Examples of machine-learning models include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

In this context, the machine-learning model 602 uses an LLM to understand, generate, and interact with human language inputs (e.g., textual prompts 210). These machine-learning models are trained on vast amounts of text data using deep learning techniques (e.g., neural networks) to learn patterns, nuances, and the structure of language. The term “large” in LLMs refers to the training data's size and the neural networks' complexity and scale, which may include billions or even trillions of parameters.

As described above, LLMs are configurable to perform a wide range of language-related tasks without being explicitly programmed for each one. To train the LLM, the underlying machine-learning model 602 is provided with training data 604 that includes examples of text to train and retrain the model to predict the next word in a sequence. Over time, the model, once trained, is configured to generate text that is coherent, contextually relevant, and mimics the style and content of the training data, and so forth.

In the illustrated example, the machine-learning model 602 is configured using a plurality of layers 606(1), . . . , 606(N) having, respectively, a plurality of nodes 608(1), . . . , 608(N). The plurality of layers 606(1)-606(N) are configurable to include an input layer, an output layer, and one or more hidden layers. Calculations are performed by the nodes 608(1)-608(N) within the layers via hidden states through a system of weighted connections that are “learned” during training to implement a variety of tasks (e.g., caption generation).

In order to train the machine-learning model 602, training data 604 is received that provides examples of “what is to be learned” by the machine-learning model 602, i.e., as a basis to learn patterns from the data. The machine-learning system 602, for instance, collects and preprocesses the training data 604 that includes input features and corresponding target labels, i.e., of what is exhibited by the input features. The machine-learning system 130 then initializes the parameters of the machine-learning model 602, which the machine-learning system 130 uses as internal variables to represent and process information during training and represent interferences gained through training. In an implementation, the training data 604 is separated into batches to improve the processing and optimization efficiency of the parameters during training. In addition, the machine-learning model 602 is trained using in-context learning by assessing a list of prior generated captions that were accepted (e.g., liked, copied, or used) by the user in relation to the provided textual prompts 210.

The training data 604 is then received as input and used to generate predictions based on the current state of parameters of layers 606(1)-606(N) and corresponding nodes 608(1)-608(N) of the model. The machine-learning model 602 outputs its result as output data 610. Output data 610 describes an outcome of the task (e.g., generating a persuasive caption).

Training the machine-learning model 602 includes calculating a loss function 612 to quantify a loss associated with operations performed by nodes 608 of the machine-learning model 602. Calculating the loss function 612, for instance, includes comparing a difference between predictions specified in the output data 610 with target labels specified by the training data 604. The loss function 612 is configurable in a variety of ways, including regression, the quadratic loss function as part of a least squares technique, and so forth.

Calculating the loss function 612 also includes using a backpropagation operation 614 to minimize the loss function 612, thereby training the parameters of the machine-learning model 602. Minimizing the loss function 612 includes adjusting the weights of the nodes 608(1)-608(N) in order to minimize the loss and thereby optimize the performance of the machine-learning model 602 for a particular task. The adjustment is determined by computing a gradient of the loss function 612, which indicates a direction to be used in order to adjust the parameters for minimizing the loss. The parameters of the machine-learning model 602 are then updated based on the computed gradient.

This process continues over a plurality of iterations until a stopping criterion 616 is met. The stopping criterion 616 is employed by the machine-learning system 130 in this example to reduce overfitting of the machine-learning model 602, reduce computational resource consumption, and promote an ability to address previously unseen data, i.e., that is not included specifically as an example in the training data 604. Examples of a stopping criterion 616 include but are not limited to a predefined number of epochs, validation loss stabilization, achievement of a performance improvement threshold, or based on performance metrics such as precision and recall.

Continuing with the procedure of system 200 of FIG. 2, the post-processing module 204 receives and processes the initial response data 212 to generate caption data 214. The post-processing includes verifying that the initial response data 212 adheres to the structural format provided in the textual prompt 210. If it does not, the initial response data 212 and/or the textual prompt 210 are returned to the machine-learning system 130 as a retry mechanism until the initial response data 212 adheres to the specified structural format.

As another example, the post-processing module 204 verifies that the initial response data 212 includes a persuasion strategy within the top three persuasion strategies associated with the content type of the input data 118. If it is not, the post-processing module 204 prompts the machine-learning system 130 to regenerate the caption. The post-processing module 204 also ensures that the essence and theme of the input data 118 are maintained while expanding it as appropriate for action request 120. The initial response data 212 is also checked for coherence and continuity in tone, style, and messaging.

The display module 206 renders or presents the caption data 214 in the user interface 138 of the display device 136 as the caption 216. In some implementations, the user has the option to provide a new action request 120 from scratch (e.g., the original input data 118) or on a portion or entirety of the generated caption 216 via the user interface 138.

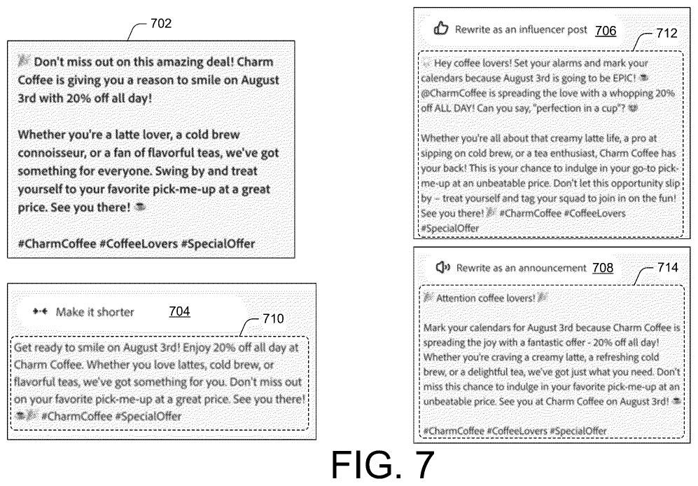

FIG. 7 illustrates an example of the generated caption 702 from the user's input in the Charm Coffee example of FIG. 5. As discussed above, the caption 702 has a specified structural format, which includes a header or introduction paragraph with a hook, a body paragraph with additional details, and a conclusion with relevant hashtags. In the user interface 138, the user may accept the generated caption 702 or is presented with several potential action requests 704, 706, and 708 for refining caption 702.

Action requests 704, 706, and 708 allow the user to “make it shorter,” “rewrite as an influencer post,” and “rewrite as an announcement,” respectively. Other potential action requests include, but are not limited to, “lengthen it,” “make first line a hook,” “improve structure and line breaks,” “add a call to action,” “rewrite as a bullet list,” “rewrite as emoji list,” “rewrite as a question,” and “rewrite to boost sales.” In response to receiving one of the action requests 704, 706, or 708, the prompt generation module 128 uses the caption 702 (or a selected portion thereof) as text 122 for textual prompt 210. The machine-learning system 130 then generates captions 710, 712, or 714, respectively. Captions 710, 712, and 714 illustrate example captions regenerated by the caption generation service 116 for this Charm Coffee scenario.

FIG. 8 illustrates an example block diagram 800 of components utilized to provide the caption generation service 116. The caption generation service 116 uses an image extraction service 802, the prompt generation module 128, the filter module 202, a machine-learning system 804, a machine-learning system interface 806, and a machine-learning system 808.

The caption generation service 116 receives input data 118 from a computing device 104, where the user inputs text 122 and digital media 124. The filter module 202 checks the input data 118 for harm and bias using the machine-learning system 804, which is trained to identify harm and bias in various media types. In some implementations, the machine-learning system 804 is part of the digital service manager module 108 to allow multiple digital services 112 to check for harm and bias in user input data. In other implementations, the machine-learning system 804 is an external machine-learning model.

The prompt generation module 128 also receives the input data 118 and uses the image extraction service 802 if an image or video is included. The image extraction service 802 processes the images or videos to extract any text and generate content tags. In some implementations, the image extraction service 802 is part of the digital service manager module 108 and is used by multiple digital services 112. In other implementations, the image extraction service 802 is exclusively used by caption generation service 116. As described above, the prompt generation module 128 uses the extracted text, content tags, and text 122 to generate a textual prompt 210, which is provided to the machine-learning system interface 806.

The machine-learning system interface 806 operatively connects the caption generation service 116 to the machine-learning system 808, which may be part of the digital service manager module 108 or be an external system. The machine-learning system interface 806 provides the textual prompt 210 to the machine-learning system 808 and performs the post-processing on the initial response data 212. Once post-processing is complete, the caption generation service 116 returns the caption 216 to the computing device 104 to be presented via user interface 138.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable individually, together, and/or combined in different ways. Thus, individual functionality, features, and concepts described in relation to different example environments, devices, components, figures, and procedures herein are usable in any suitable combinations and are not limited to the particular combinations represented by the enumerated examples in this description.

### Example Caption Generation Procedure

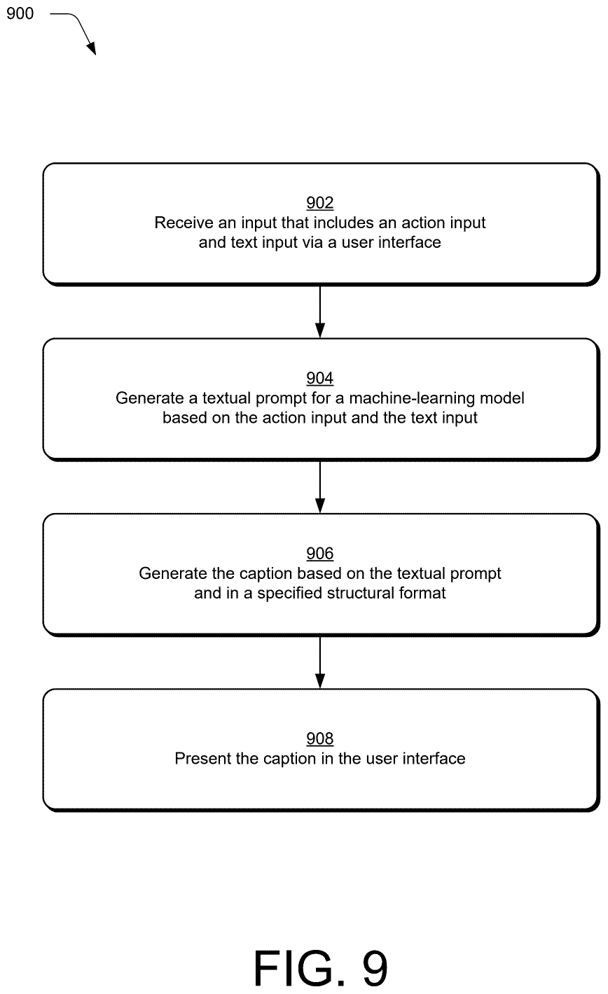

The following discussion describes techniques that are implementable utilizing the previously described systems and devices. Aspects of the procedure are implementable in hardware, firmware, software, or a combination thereof. The procedure is illustrated as a set of blocks that specify operations performed by one or more devices and are not necessarily limited to the orders shown for performing the operations by the respective blocks. In portions of the following discussion, reference is made to FIGS. 1 through 8. FIG. 9 is a flow diagram depicting procedure 900 in an example implementation in which a machine-learning model generates a caption from digital content.

An input, including an action input and a text input, is received via a user interface (block 902). For example, the service provider system 102 receives the input via the user interface 138 of the computing device 104. The action input indicates an action to be performed (e.g., lengthen, shorten, make persuasive). The text input indicates example language or content for the caption. In one example, the text input includes words input by the user providing details for or an initial draft of the caption. In another example, the text input is extracted text or content tags associated with digital media uploaded by the user.

A textual prompt is generated for a machine-learning model based on the action and text inputs (block 904). For example, the prompt generation module 128 uses the action request 120, the text 122, and/or media prompt 318 to generate the textual prompt 210 for the machine-learning system 130. Based on the textual prompt, the machine-learning model generates a caption in a specified structural format (block 906). The specified structural format in one example is a JSON data format that includes a header, one or more body paragraphs, and a conclusion. The generated caption is then presented to a user via the user interface (block 908).

### Example System and Device

FIG. 10 illustrates an example system 1000 that includes an example computing device that is representative of one or more computing systems and/or devices that are usable to implement the various techniques described herein. This is illustrated through the inclusion of the caption generation service 116. The computing device 1002 includes, for example, a server of a service provider, a device associated with a client (e.g., a client device), an on-chip system, and/or any other suitable computing device or computing system.

The example computing device 1002, as illustrated, includes a processing system 1004, one or more computer-readable media 1006, and one or more I/O interfaces 1008 that are communicatively coupled, one to another. Although not shown, the computing device 1002 further includes a system bus or other data and command transfer system that couples the various components from one to another. For example, a system bus includes any combination of different bus structures, such as a memory bus or memory controller, a peripheral bus, a universal serial bus, and/or a processor or local bus that utilizes various bus architectures. A variety of other examples are also contemplated, such as control and data lines.

The processing system 1004 is representative of the functionality to perform one or more operations using hardware. Accordingly, the processing system 1004 is illustrated as including hardware elements 1010 that are configured as processors, functional blocks, and so forth. This includes example implementations in hardware as an application specific integrated circuit or other logic device formed using one or more semiconductors. The hardware elements 1010 are not limited by the materials from which they are formed or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 1006 is illustrated as including memory/storage 1012. Memory/storage 1012 represents memory or storage capacity associated with one or more computer-readable media. In one example, the memory/storage 1012 includes volatile media (such as random access memory (RAM)) and/or nonvolatile media (such as read-only memory (ROM), Flash memory, optical disks, magnetic disks, and so forth). In another example, the memory/storage 1012 includes fixed media (e.g., RAM, ROM, a fixed hard drive, and so on) as well as removable media (e.g., Flash memory, a removable hard drive, an optical disc, and so forth). The computer-readable media 1006 is configurable in a variety of other ways, as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 is configurable in a variety of ways, as further described below, to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on a variety of commercial computing platforms having a variety of processors.

Implementations of the described modules and techniques are stored on or transmitted across some form of computer-readable media. For example, the computer-readable media includes a variety of media accessible to the computing device 1002. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal-bearing media. The computer-readable storage media includes hardware such as volatile and non-volatile, removable and non-removable media, and/or storage devices implemented in a method or technology suitable for storage of information such as computer-readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium configured to transmit instructions to the hardware of the computing device 1002, such as via a network. Signal media typically embodies computer-readable instructions, data structures, program modules, or other data in a modulated data signal, such as carrier waves, data signals, or other transport mechanisms. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic, and/or fixed device logic implemented in a hardware form that is employable in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as hardware utilized to store instructions for execution, e.g., the computer-readable storage media described previously.

Combinations of the foregoing are also employable to implement various techniques described herein. Accordingly, software, hardware, or executable modules are implementable as instructions and/or logic embodied on some form of computer-readable storage media and/or by one or more hardware elements 1010. For example, the computing device 1002 is configured to implement particular instructions and/or functions corresponding to the software and/or hardware modules. Accordingly, implementation of a module that is executable by the computing device 1002 as software is achieved at least partially in hardware, e.g., through the use of computer-readable storage media and/or hardware elements 1010 of the processing system 1004. The instructions and/or functions are executable/operable by one or more articles of manufacture (for example, one or more computing devices 1002 and/or processing systems 1004) to implement techniques, modules, and examples described herein.

The techniques described herein are supportable by various configurations of the computing device 1002 and are not limited to the specific examples of the techniques described herein. This functionality is also implementable entirely or partially through the use of a distributed system, such as over a “cloud” 1014, as described below.

The cloud 1014 includes and/or is representative of a platform 1016 for resources 1018. The platform 1016 abstracts the underlying functionality of hardware (e.g., servers) and software resources of the cloud 1014. For example, the resources 1018 include applications and/or data that are utilized while computer processing is executed on servers remote from the computing device 1002. In some examples, the resources 1018 also include services provided over the Internet and/or through a subscriber network, such as a cellular or Wi-Fi network.

The platform 1016 abstracts the resources 1018 and functions to connect the computing device 1002 with other computing devices. In some examples, the platform 1016 also serves to abstract scaling of resources to provide a corresponding level of scale to encountered demand for the resources implemented via the platform. Accordingly, in an interconnected device embodiment, the implementation of functionality described herein is distributable throughout the system 1000. For example, the functionality is implementable in part on the computing device 1002 as well as via the platform 1016 that abstracts the functionality of the cloud 1014.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

What is claimed is:

1. A method comprising:
receiving, by a processing device, an input via a user interface, the input including an action input that indicates an action to be performed and a text input for a caption;
generating, by the processing device and based on the action input and the text input, a textual prompt for a machine-learning model;
generating, by the machine-learning model and based on the textual prompt, the caption in a specified structural format; and
presenting, by the processing device, the caption via the user interface.

2. The method of claim 1, wherein the specified structural format of the caption includes:
a header followed by at least one return line; and
one or more paragraphs separated and followed by the at least one return line.

3. The method of claim 2, wherein the specified structural format further includes:
one or more non-text characters in the header or the one or more paragraphs; and
one or more non-text contextual characters in a conclusion line after the one or more paragraphs.

4. The method of claim 2, wherein:
the input also includes a distribution channel input that indicates one or more distribution channels for the caption; and
a maximum length of the caption is determined based on the one or more distribution channels indicated in the distribution channel input.

5. The method of claim 1, wherein the input also includes media content to accompany the caption, the media content including a digital image, a digital video, or a digital audio message.

6. The method of claim 5, wherein generating the textual prompt comprises:
extracting text from the media content; or
extracting content tags from the media content that describe the media content in words; and
providing the extracted text or the content tags to the processing device as part of the text input for generating the textual prompt.

7. The method of claim 6, wherein:
the media content is a digital image, a digital video, or a digital audio file; and
the text input includes the extracted text or the content tags from the digital image, the digital video, or the digital audio file.

8. The method of claim 1, wherein the machine-learning model is configured to identify missing details for the caption and insert a placeholder for a user to insert the missing details.

9. The method of claim 1, wherein the machine-learning model is trained to maintain a tone, a style, or messaging of the text input.

10. The method of claim 1, wherein the machine-learning model is trained using prior responses accepted and not accepted by a user to generate the caption for the user.

11. The method of claim 1, wherein the method further comprises:
reviewing, by the processing device, the input to determine whether the input includes one or more words or phrases included on a block-and-deny list; and
in response to determining that the input includes one or more words or phrases on the block-and-deny list, generating, by the processing device, an alert for presentation on the user interface that caption generation is not available for the input.

12. The method of claim 1, wherein the action input includes at least one of shortening, lengthening, rewriting, or improving persuasiveness of the text input.

13. The method of claim 1, wherein the textual prompt indicates a persuasion strategy for the machine-learning model, the persuasion strategy selected from at least two of social identity, tone, readability, social proof, concreteness, emotion, anthropomorphism, guarantees, anchoring and comparison, or foot in door.

14. A system comprising:
a memory component; and
a processing device coupled to the memory component, the processing device configured to:
receive, via a user interface, an input that includes media content;
generate, based on the media content, a textual prompt for a machine-learning model to generate a caption;
generate, by the machine-learning model, the caption based on the textual prompt and in a specified structural format; and
present the caption via the user interface.

15. The system of claim 14, wherein the specified structural format of the caption includes:
a header followed by at least one return line; and
one or more paragraphs separated and followed by the at least one return line.

16. The system of claim 15, wherein:
the input also includes a distribution channel input that indicates one or more distribution channels for the caption; and
the processing device is further configured to determine a maximum length of the caption based on the one or more distribution channels indicated in the distribution channel input.

17. The system of claim 14, wherein:
the media content includes a digital image, a digital video, or a digital audio message; and
the processing device is further configured to:
extract text from the media content; or
extract content tags from the media content that describe the media content in words; and
provide the extracted text or the content tags as part of the textual prompt.

18. A non-transitory computer-readable storage medium storing executable instructions, which when executed by a processing device, cause the processing device to perform operations comprising:
receiving, via a user interface, an input that includes an action input that indicates an action to be performed and a text input for a caption;
generating, based on the action input and the text input, a textual prompt for a machine-learning model;
generating, by the machine-learning model, the caption based on the textual prompt and in a specified structural format; and
presenting the caption via the user interface.

19. The non-transitory computer-readable storage medium of claim 18, wherein the specified structural format of the caption includes:
a header followed by at least one return line; and
one or more paragraphs separated and followed by the at least one return line.

20. The non-transitory computer-readable storage medium of claim 18, wherein:
the input also includes media content to accompany the caption, the media content including a digital image, a digital video, or a digital audio message; and
the non-transitory computer-readable storage medium stores additional executable instructions, which when executed by the processing device, cause the processing device to:
extract text from the media content; or
extract content tags from the media content that describe the media content in words; and
provide the extracted text or the content tags as part of the text input for generating the textual prompt.
